(19) United States
(12) Patent Application Publication
(10) Pub. No.: US 2021/0282404 A1
(43) Pub. Date: Sep. 16, 2021

(54) BIOLOGICAL METHODS FOR CONTROLLING PHYTOPATHOGENIC FUNGI

(71) Applicant: Bayer SAS, Lyon (FR)

(72) Inventor: Patrice DUBOURNET, Vourles (FR)

(73) Assignee: Bayer SAS, Lyon (FR)

(21) Appl. No.: 17/259,470

(22) PCT Filed: Jul. 15, 2019
(86) PCT No.: PCT/EP2019/069043

§ 371 Date: Jan. 11, 2021

(30) Foreign Application Priority Data
Jul. 17, 2018 (EP) 18183999.4

(51) Int. Cl. A01N 63/22; G06Q 50/02

(52) U.S. Cl. CPC A01N 63/22; G06Q 50/02

(57) ABSTRACT

The present invention relates to methods for controlling phytopathogenic fungi using biological control agents. More specifically, the invention relates to methods for controlling phytopathogenic fungi having a long incubation period. In particular, the methods according to the invention are particularly suited for controlling the causal agent of powdery mildew on grapes, the fungus Erysiphe necator.

The present invention relates to methods for controlling phytopathogenic fungi using biological control agents. More specifically, the invention relates to methods for controlling phytopathogenic fungi having a long incubation period. In particular, the methods according to the invention are particularly suited for controlling the causal agent of powdery mildew on grapes, the fungus Erysiphe necator.

### BACKGROUND

Several synthetic chemical solutions have been developed and commercialized to control fungal diseases. However, there is a growing demand of consumers for food products that would have been less treated with synthetic chemical products during their production. In order to address this demand, biological control agents are being developed.

Most biological control agents having a fungicidal activity are usually recommended to growers to be applied on crop plants before the fungal disease is actually installed, i.e. before visual symptoms of the disease are observed by the grower.

However, many phytopathogenic fungi have long incubation periods, i.e. visual symptoms of the disease appear several weeks after the fungus has actually infected the plants. With regard to such fungi, an application before visualizing symptoms may actually not correspond to the optimal application time because, although symptoms are not yet visible, the disease may already be well installed in the plant.

Grapevine powdery mildew caused by Erysiphe necator (also known as Uncinula necator) is one of the most widespread diseases of grapevine (Vitis vinifera L.) worldwide. Erysiphe necator belong to the ascomycetes and is an obligate biotrophic fungus, i.e. its growth and reproduction are fully dependent on its living grapevine host (grapes and leaves). Erysiphe necator is a phytopathogenic fungus with a long incubation period, that can last several weeks.

The biological strain Bacillus pumilus QST2808 (also referred to as NRRL No. B-30087) is described in WO 00/58442 as being active against certain plant diseases. More specifically, Bacillus pumilus strain QST2808 has been shown to have some capacity to control the grape powdery mildew Erysiphe necator when tested in experimental controlled conditions where the pathogen and the treatments are applied concomitantly. These data show that the biological strain Bacillus pumilus QST2808 has some capacity to control the grape powdery mildew Erysiphe necator, but it does not provide any information as to whether this capacity could be more or less efficient depending on the stage of infestation of the grapevine plants. It is therefore assumed from WO 00/58442 that the capacity of Bacillus pumilus strain QST2808 to control Erysiphe necator is similar whatever the level of infestation, and that a treatment at any time of the infestation is as efficient.

The inventors of the present invention have identified that biological control agents do better control fungus with long incubation periods if the biological control agent is applied at the beginning of the incubation period. More particularly, they have identified that the biological strain Bacillus pumilus QST2808 controls the grape powdery mildew Erysiphe necator much better in field conditions if it is applied during the early stage of the incubation period by the fungus. The same has also been noticed for some other biological control agents. These biological control agents were already suggested to work better before infestation, i.e. before the first symptoms of the disease become visible on the grapevine plants. Applying a product prior to seeing the signs of a disease infestation is however a challenge for plant growers, since they have little tools except than observing the first symptoms of diseases on plants in their fields or in neighboring fields. When growers have to face infestations by fungi having long incubation periods, applying a biological control agent before visualizing symptoms may actually be too late for an optimal efficacy of such product if the fungi is already at a stage of infestation that is in the late stage of the incubation period, i.e. when the fungi is already well installed in the crop. Moreover, treatments are costly for growers and they prefer to apply one only if they are convinced that it is necessary to do so. Indeed, treating in the absence of any visible signs bears either the risk of treating for nothing because there would be no infestation in the field, or the risk of treating too early on the field and seeing the treatment being washed by rain before an infestation comes.

These risks become even more true when it comes to the disease caused by a fungus having a long incubation time, like for example the fungus Erysiphe necator in grapevines. The fungus Erysiphe necator, like most fungi having long incubation periods, has indeed the particularity that its symptoms become visible to human eye on grapevines usually only several weeks after actual infestation of the plants. It is therefore difficult for grape growers to assess whether their grapevines are actually infected before they can observe visual symptoms on the plants, but when such symptoms become visible, the infestation is already well installed in the infected plants. Biological control agents like the biological strain Bacillus pumilus QST2808 are known to still have some efficacy when applied at such time when the first symptoms become visible on some grapevine plants in the field. Usually, growers collect information from neighboring fields, together with weather data, for assessing their risk of infection. When visual symptoms have actually been observed in neighboring fields and the weather conditions correspond to those favorable to the development of the fungus, they do consider that their own field is at risk of infestation and they consider their crop to be in a situation of pre-infestation. However, for fungi like Erysiphe necator, such stage usually corresponds to a situation of actual infection of the crop by the fungus, which is already late in its incubation period and close to create damages to the plants such that visual symptoms will soon become observable.

In order to try improving grower's ability to know whether their vineyard is infected by a fungus having a long incubation period prior to the apparition of visual symptoms of the disease, and therefore possibly apply some treatments earlier, certain precise detection tools have been developed, such as qPCR, which are able to detect very low quantities of the fungus on the plant. Such a tool is for example described in WO2017/009251 for the fungus Erysiphe necator.

However, although the biological strain Bacillus pumilus QST2808 is known to be more effective before infestation by Erysiphe necator, understood as meaning before observation of the first visual symptoms in the field compared as to when the infestation is well visible on most plants of the field, there is no evidence that a treatment with such product applied much earlier in the infestation process would be as efficient.

Using the precise detection tools, the inventors have identified that biological control agents such as Bacillus pumilus strain QST2808 are even more effective when applied very early in the infestation process of Erysiphe necator, and therefore that a method using such precise detection tools for positioning a treatment at the early infestation stage enables to optimize the efficacy of products like Bacillus pumilus strain QST2808. This finding is considered to likely apply similarly to the treatment with biological control agents of other fungal diseases caused by fungi having long incubation periods.

### DESCRIPTION OF THE INVENTION

The present invention provides a method for controlling a plant fungal pathogen having a long incubation period using a biological control agent, characterized in that an effective amount of the biological control agent is applied on the plant when the infection by the plant fungal pathogen is at the beginning of the incubation period.

Similarly, when considering a crop field made of several hundreds or thousands of plants, the invention provides a method for controlling a plant fungal pathogen having a long incubation period using a biological control agent, characterized in that an effective amount of the biological control agent is applied on the crop field when the infection by the plant fungal pathogen is at the beginning of the incubation period on average over the crop field.

In infectious diseases, the “incubation period” is the time lasting from the moment the host becomes infected by a pathogen until the moment when the first symptoms become observable. In the case of plant fungal pathogens, the incubation period therefore corresponds to the period of time between the moment when the host plant (for a given host-pathogen relationship) becomes in contact with the pathogen and the moment when the first symptoms of the disease become observable on certain plant parts. For plant pathogens, this incubation period is usually considered to correspond to a period of time during which the pathogen multiplies itself on the surface of certain plant parts (e.g. leaves, roots, fruits . . . ), penetrates such plant parts using special infesting organs (haustoria), grows among plant cells and feeds on them to such an extent that the biological deteriorations caused by such infestation create certain symptoms, specific to the disease, to become observable by a human eye on the infected plant parts. It is therefore understood that observable symptoms are not part of the period designated as the incubation period, and that the moment of their observation is actually the end of the incubation period. The moment when the host plant becomes in contact with the pathogen is usually referred to as the infection stage, and can consist of a single pathogen infectious body entering in physical contact with a plant part. For fungal pathogens, such single pathogen infectious body is usually a reproductive and propagation body of the pathogen such as a spore. The symptoms can take various forms depending on the host-pathogen relationship considered, from symptoms affecting the growth of the plants (under- or over-development of certain organs, alteration of the normal appearance, e.g. leaf spots, vein bands, leaf distortion, coating with mycelia or spores . . . ), or necrosis of certain plant parts (decays and rots of certain plant parts). Examples of symptoms for certain plant-pathogen relationship are given in Sambamurty (2006), Textbook of plant pathology, IK International Pvt Ltd, 416p.

A plant fungal pathogen having a long incubation period is a fungus pathogenic to certain plants which has an incubation period lasting several days, preferably several weeks. More preferably, a plant fungal pathogen having a long incubation period is a fungus having an incubation period of at least one week, at least two weeks, at least three weeks, most preferably at least a month. The incubation period highly depends on the plant pathogen and the host plant it infects, but may also be influenced by environmental factors such as temperature, day light or humidity. Accordingly, the incubation period is understood as an average incubation period of a given plant pathogen on a given plant. An average long incubation period is an incubation period from about 2 weeks to about 16 weeks, more precisely from about 2 weeks to about 12 weeks, from about 2 weeks to about 8 weeks, from about 2 weeks to about 4 weeks, from about 3 weeks to about 4 weeks.

Non-limiting examples of plant fungal pathogens having long incubation periods are: the grape powdery mildew (Erysiphe necator), the grey mould (Botrytis cinerea), Septoria leaf blotch (Mycosphaerella graminicola), Septoria nodorum blotch (Phaeosphaeria nodorum).

According to the method of the invention, the biological control agent is applied on the plant, or the crop field, when the infection by the plant fungal pathogen is at the beginning of the incubation period. It is understood that, for a given fungal pathogen, the infection is considered at the beginning of the incubation period during a period lasting from the time some infectious bodies of the fungal pathogen (e.g. its spores) come into contact with the host plant until the time the fungus starts growing on the surface of the plant. Since those events are not visible to human eye, certain detection means are necessary to identify such time when the infection by the plant fungal pathogen is at the beginning of the incubation period. A description of suitable detection means is made in P. Narayanasamy, 2011, Microbial Plant Pathogens-Detection and Disease Diagnosis: Fungal Pathogens, Vol. 1, ed. Springer Science+Business Media: 5-199.

A preferred detection method is the qPCR, as described for example in International PCT Patent Applications WO95/29260 or WO2017/009251.

Whatever the detection method used, the determination that the infection by the plant fungal pathogen is at the beginning of the incubation period may depend on a number of factors and may therefore be assessed by different methods.

Preferably, the determination of the level of infection of the plant by the fungal pathogen is made at the level of a crop field. In such situation, the level of infection is determined statistically by randomly sampling and assessing a certain number of plants over the entire field. The number of samples taken depends on the total number of plants in the field. Statistical methods enable the determination of a sample size that is representative of the entire field. The random sampling may be made by collecting plant material of at least 10 plants, at least 20 plants, at least 50 plants, or at least 100 plants. The plant parts collected depend on the nature of the crop grown in the field, but also the pathogen intended to be assessed. Certain fungal pathogens indeed affect only certain parts of the plants. In the case of measuring a possible early infection by the grape powdery mildew Erysiphe necator in a grapevine field, preferably leaves are collected as material, and they are preferably collected before flowering of the plants. According to this sampling method, an infection is considered to be at the beginning of the incubation period if, after measurement of the fungal pathogen using a detection method, the detection reveals less than 50% of the samples infected, preferably less than 40%, 30%, 20%, 10%, more preferably less than 5%, and even more preferably less than 1%.

In certain situations, it may be necessary to determine the level of infection of individual plants. For such determinations, detection tools that allow to quantitatively measuring the level of infection by the fungal pathogen are preferred. In such cases, the sampling may be made over different parts of the plants, also depending on the nature of the plant and of the fungal pathogen intended to be tested. When quantitative measures are made, the level of infection considered to be at the beginning of the incubation period is very much dependent on the detection method used. It can however be considered that a measure corresponding to a level of infection at the beginning of the incubation period is a low level of detection. Accordingly, the skilled person will know, considering the plant and the fungal pathogen to be tested and the detection methods to be used, what measure is to be considered as a level of infection that is at the beginning of the incubation period.

Accordingly, the invention also provides for a method for controlling the infestation of a plant by a plant fungal pathogen having a long incubation period using a biological control agent, comprising the steps of:
(a) determining the stage of infection of the plant by the plant fungal pathogen before visual symptoms are observable, using a means of detection of the plant fungal pathogen;
(b) applying an effective amount of the biological control agent on the plant when the determination of step (a) reveals that the infection by the plant fungal pathogen is at the beginning of the incubation period.

In addition to the use of detection methods, additional information known to be associated with a risk of infection by the fungal pathogen may also be taken into consideration for determining that the level of infection is at the beginning of the incubation period, or for determining the ideal moment for assessing the level of infection with one of the detection methods. Indeed, the infection by fungal pathogens is known to be influenced by certain environmental factors such as for example hygrometry, air temperature or day light. Moreover, information about the infection status by a given fungal pathogen in neighboring fields may be relevant for determining a risk of infection in a given field. All these additional information may be used to determine a risk of infection in a given field and thereby guide the optimal timing for assessing the level of infection using one of the detection methods in such given field. Accordingly, it is considered that, when the set of additional information for a given fungal pathogen concurs towards a determination of a risk of imminent infection in a given field, it is then appropriate to assess the actual level of infection of the field using one of the detection methods. All the additional information relevant for a given fungal pathogen and crop may be measured by appropriate means available to the skilled person, who may then also be able to interpret such additional information for determining a risk of infection of a given field. These additional information may also be collected from various sources and entered into a digital tool comprising one or more computer programs aimed at calculating a risk of infection of a given field based on these additional information.

Accordingly, the invention also provides for a method for controlling the infestation of a crop field by a plant fungal pathogen having a long incubation period using a biological control agent, comprising the steps of:
(a) determining if the crop field is at risk of infection by the plant fungal pathogen, by measuring certain parameters associated with the development of the plant fungal pathogen, the resulting information of those measures being used for then calculating a probability of such development in the crop field;
(b) if the determination of step (a) finds that the crop field is at risk, then determining the stage of infection of the field by the plant fungal pathogen before visual symptoms are observable, using a means of detection of the plant fungal pathogen;
(c) applying an effective amount of the biological control agent on the field when the determination of step (a) reveals that the infection by the plant fungal pathogen is at the beginning of the incubation period.

According to a particular embodiment, the invention is a method for controlling the fungal pathogen grape powdery mildew using a biological control agent, characterized in that an effective amount of the biological control agent is applied on the grapevines when the infection by the plant fungal pathogen is at the beginning of the incubation period. The grapevine powdery mildew is the fungus Erysiphe necator (also known as Uncinula necator). This fungus affects various grapevine varieties or cultivars of the species Vitis vinifera L.

As used herein, the term “control” or “controlling” essentially means reducing the capacity to grow or to develop of a given fungal pathogen on a given plant, preferably a crop plant, thereby reducing the development of symptoms caused by this disease on the concerned plant. According to a particular embodiment, the fungal pathogen is the fungus Erysiphe necator, and the crop plant is any variety or cultivar of the species Vitis vinifera L.

In agriculture, a “biological control agent” is usually defined as an agent for controlling pests, diseases or weeds that affect the growth of plants, more particularly crop plants, and which consists either of a living organism or a product or composition obtained from a living organism, or a mixture thereof. According to the present invention, biological control agents are microorganisms, more particularly bacteria and/or products or compositions obtained therefrom and/or mixtures thereof. A product or composition obtained from a microorganism may be a product extracted from the cells of such microorganism. More preferably, a product or composition obtained from a microorganism is a product or composition that is synthesized by such microorganism and secreted into a medium where such microorganism is fermented to live and grow, such as e.g. a culture broth. Such latter types of products are also designated as fermentation products.

Examples of biological control agents which may be used in the methods according to the invention are:

Bacteria, for example (B1.1) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (B1.2) Bacillus pumilus, in particular strain QST2808 (available as SONATA® from Bayer CropScience LP, US, having Accession No. NRRL B-30087 and described in U.S. Pat. No. 6,245,551); (B1.3) Bacillus pumilus, in particular strain GB34 (available as Yield Shield® from Bayer AG, DE); (B1.4) Bacillus pumilus, in particular strain BU F-33 (having NRRL Accession No. 50185); (B1.5) Bacillus amyloliquefaciens, in particular strain D747 (available as Double Nickel™ from Certis, US, having accession number FERM BP-8234 and disclosed in U.S. Pat. No. 7,094,592); (B1.6) Bacillus subtilis Y1336 (available as BIOBAC® WP from Bion-Tech, Taiwan, registered as a biological fungicide in Taiwan under Registration Nos. 4764, 5454, 5096 and 5277); (B1.7) Bacillus amyloliquefaciens strain MBI 600 (available as SUBTILEX from BASF SE); (B1.8) Bacillus subtilis strain GB03 (available as Kodiak® from Bayer AG, DE); (B1.9) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (B1.10) Bacillus mycoides, isolate J (available as BmJ TGAI or WG from Certis USA); (B1.11) Bacillus licheniformis, in particular strain SB3086 (available as EcoGuard™ Biofungicide and Green Releaf from Novozymes); (B1.12) a Paenibacillus sp. strain having Accession No. NRRL B-50972 or Accession No. NRRL B-67129 and described in International Patent Publication No. WO 2016/154297.
In some embodiments, the biological control agent is a Bacillus subtilis or Bacillus amyloliquefaciens strain that produces a fengycin or plipastatin-type compound, an iturin-type compound, and/or a surfactin-type compound. For background, see the following review article: Ongena, M., et al., “Bacillus Lipopeptides: Versatile Weapons for Plant Disease Biocontrol,” Trends in Microbiology, Vol 16, No. 3, March 2008, pp. 115-125. Bacillus strains capable of producing lipopeptides include Bacillus subtilis QST713 (available as SERENADE OPTI or SERENADE ASO from Bayer CropScience LP, US, having NRRL Accession No. B21661 and described in U.S. Pat. No. 6,060,051), Bacillus amyloliquefaciens strain D747 (available as Double Nickel™ from Certis, US, having accession number FERM BP-8234 and disclosed in U.S. Pat. No. 7,094,592); Bacillus subtilis MBI600 (available as SUBTILEX® from Becker Underwood, US EPA Reg. No. 71840-8); Bacillus subtilis Y1336 (available as BIOBAC® WP from Bion-Tech, Taiwan, registered as a biological fungicide in Taiwan under Registration Nos. 4764, 5454, 5096 and 5277); Bacillus amyloliquefaciens, in particular strain FZB42 (available as RHIZOVITAL® from ABiTEP, DE); and Bacillus subtilis var. amyloliquefaciens FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); and
Fungi, for example: (B2.1) Coniothyrium minitans, in particular strain CON/M/91-8 (Accession No. DSM-9660; e.g. Contans® from Bayer); (B2.2) Metschnikowia fructicola, in particular strain NRRL Y-30752 (e.g. Shemer®); (B2.3) Microsphaeropsis ochracea (e.g. Microx® from Prophyta); (B2.5) Trichoderma spp., including Trichoderma atroviride, strain SC1 described in International Application No. PCT/IT2008/000196); (B2.6) Trichoderma harzianum rifai strain KRL-AG2 (also known as strain T-22, /ATCC 208479, e.g. PLANTSHIELD T-22G, Rootshield®, and TurfShield from BioWorks, US); (B2.14) Gliocladium roseum, strain 321U from W.F. Stoneman Company LLC; (B2.35) Talaromyces flavus, strain V117b; (B2.36) Trichoderma asperellum, strain ICC 012 from Isagro; (B2.37) Trichoderma asperellum, strain SKT-1 (e.g. ECO-HOPE® from Kumiai Chemical Industry); (B2.38) Trichoderma atroviride, strain CNCM 1-1237 (e.g. Esquive® WP from Agrauxine, FR); (B2.39) Trichoderma atroviride, strain no. V08/002387; (B2.40) Trichoderma atroviride, strain NMI no. V08/002388; (B2.41) Trichoderma atroviride, strain NMI no. V08/002389; (B2.42) Trichoderma atroviride, strain NMI no. V08/002390; (B2.43) Trichoderma atroviride, strain LC52 (e.g. Tenet by Agrimm Technologies Limited); (B2.44) Trichoderma atroviride, strain ATCC 20476 (IMI 206040); (B2.45) Trichoderma atroviride, strain T11 (IM1352941/CECT20498); (B2.46) Trichoderma harmatum; (B2.47) Trichoderma harzianum; (B2.48) Trichoderma harzianum rifai T39 (e.g. Trichodex® from Makhteshim, US); (B2.49) Trichoderma harzianum, in particular, strain KD (e.g. Trichoplus from Biological Control Products, SA (acquired by Becker Underwood)); (B2.50) Trichoderma harzianum, strain ITEM 908 (e.g. Trianum-P from Koppert); (B2.51) Trichoderma harzianum, strain TH35 (e.g. Root-Pro by Mycontrol); (B2.52) Trichoderma virens (also known as Gliocladium virens), in particular strain GL-21 (e.g. SoilGard 12G by Certis, US); (B2.53) Trichoderma viride, strain TV1(e.g. Trianum-P by Koppert); (B2.54) Ampelomyces quisqualis, in particular strain AQ 10 (e.g. AQ 10® by IntrachemBio Italia); (B2.56) Aureobasidium pullulans, in particular blastospores of strain DSM14940; (B2.57) Aureobasidium pullulans, in particular blastospores of strain DSM 14941; (B2.58) Aureobasidium pullulans, in particular mixtures of blastospores of strains DSM14940 and DSM 14941 (e.g. Botector® by bio-ferm, CH); (B2.64) Cladosporium cladosporioides, strain H39 (by Stichting Dienst Landbouwkundig Onderzoek); (B2.69) Gliocladium catenulatum (Synonym: Clonostachys rosea f. catenulate) strain J1446 (e.g. Prestop® by AgBio Inc. and also e.g. Primastop® by Kemira Agro Oy); (B2.70) Lecanicillium lecanii (formerly known as Verticillium lecanii) conidia of strain KV01 (e.g. Vertalec® by Koppert/Arysta); (B2.71) Penicillium vermiculatum; (B2.72) Pichia anomala, strain WRL-076 (NRRL Y-30842); (B2.75) Trichoderma atroviride, strain SKT-1 (FERM P-16510); (B2.76) Trichoderma atroviride, strain SKT-2 (FERM P-16511); (B2.77) Trichoderma atroviride, strain SKT-3 (FERM P-17021); (B2.78) Trichoderma gamsii (formerly T. viride), strain ICC080 (IMI CC 392151 CABI, e.g. BioDerma by AGROBIOSOL DE MEXICO, S.A. DE C.V.); (B2.79) Trichoderma harzianum, strain DB 103 (e.g., T-Gro 7456 by Dagutat Biolab); (B2.80) Trichoderma polysporum, strain IMI 206039 (e.g. Binab TF WP by BINAB Bio-Innovation AB, Sweden); (B2.81) Trichoderma stromaticum (e.g. Tricovab by Ceplac, Brazil); (B2.83) Ulocladium oudemansii, in particular strain HRU3 (e.g. Botry-Zen® by Botry-Zen Ltd, NZ); (B2.84) Verticillium albo-atrum (formerly V. dahliae), strain WCS850 (CBS 276.92; e.g. Dutch Trig by Tree Care Innovations); (B2.86) Verticillium chlamydosporium; (B2.87) mixtures of Trichoderma asperellum strain ICC 012 and Trichoderma gamsii strain ICC 080 (product known as e.g. BIO-TAM™ from Bayer CropScience LP, US).

According to a preferred embodiment, the biological control agent comprises the bacterial strain Bacillus pumilus QST2808, its mutants, their fermentation products, or a mixture thereof. The bacterial strain Bacillus pumilus QST2808 is described in the International PCT Patent Application published as WO 00/58442. In WO 00/58442, the strain is referred to as NRRL No. B-30087, which is synonymous with Bacillus pumilus QST2808. Bacillus pumilus QST2808 was deposited with the NRRL on Jan. 14, 1999, under the provisions of the Budapest Treaty on the International Recognition of the Deposit of Microorganisms for the Purpose of Patent Procedure under Accession Number B-30087. Such a biological control agent is available commercially under the brand name Sonata®.

According to another embodiment, the biological control agent is a composition comprising compounds obtained from a living organism. An example of such composition is a composition comprising chito-oligo-saccharides, also known as COS, obtainable from fungal cell walls or crustacean exoskeletons. Another example is a composition comprising pectin-derived oligo-galacturonides, also known as OGA, obtainable from various plant cell walls. COS and OGA are known to be elicitors of the plant's natural defense mechanisms. A preferred composition is a composition comprising chito-oligo-saccharides and oligo-galacturonides, such as the one described in European patent application EP2115066. Such a biological control agent is available commercially under the brand name Bastid®.

According to another embodiment, the biological control agent comprises an extract (cell walls) of the yeast Saccharomyces cerevisiae, more specifically Saccharomyces cerevisiae strain LAS117, its mutants, their fermentation products, or a mixture thereof. Such a biological control agent is described in International PCT Patent Application published as WO2007/074303. Such a biological control agent is available commercially under the brand name Romeo®.

According to another embodiment, the biological control agent comprises the fungal strain Ampelomyces quisqualis AQ10, its mutants, their fermentation products, or a mixture thereof. The fungal strain Ampelomyces quisqualis AQ10 is described in European Patent Application EP0353662. Such a biological control agent is available commercially under the brand name AQ 100.

According to another embodiment, the biological control agent comprises the bacterial strain Bacillus amyloliquefaciens subsp. plantarum strain D747, its mutants, their fermentation products, or a mixture thereof. Such a biological control agent is available commercially under the brand name Amylo-X®.

According to another embodiment, the biological control agent comprises an extract of the tea tree plant (Melaleuca alternifolia). Such a biological control agent is described in the International PCT Patent Application published as WO2011/140309. Such a biological control agent is available commercially under the brand name Timorex Gold®.

According to another embodiment, the biological control agent comprises an extract of the seaweeds Ascophyllum nodosum. Such a biological control agent is available commercially under the brand name Alginure®.

According to another embodiment, the biological control agent comprises a composition comprising an extract of Citrus sp. oil. Such a biological control agent is described in European Patent Application EP2200429. Such a biological control agent is available commercially under the brand name Prev-Am®.

According to another embodiment, the biological control agent comprises an extract of the plant Reynoutria sachalinensis. Such a biological control agent is described in the International PCT Patent Application published as WO2011/014596. Such a biological control agent is available commercially under the brand name Regalia®.

With regard to a biological control agent, the term “mutant” refers to a genetic variant derived from the concerned living organism making the biological control agent. In one embodiment, the mutant has one or more or all the identifying characteristics (its biological control functionality) of the concerned living organism of the biological control agent. In a particular instance, the mutant or a fermentation product thereof has a biological control characteristic at least as good as the concerned parent living organism. Such mutants may be genetic variants having a genomic sequence that has greater than about 85%, greater than about 90%, greater than about 95%, greater than about 98%, or greater than about 99% sequence identity to the concerned living organism. Mutants may be obtained by treating the concerned living organism cells with chemicals or irradiation or by selecting spontaneous mutants from a population of such cells (such as phage resistant or antibiotic resistant mutants) or by other means well known to those practiced in the art.

Products or compositions of the present invention can be obtained by culturing the concerned living organism making the biological control agent, according to methods well known in the art, including for example with regard to the biological control agent Bacillus pumilus strain QST2808, use of the media and other methods described in International PCT Patent Application published as WO 00/58442.

When the biological control agent is made of or from a microorganism, more particularly a bacteria, conventional large-scale microbial culture processes include submerged fermentation, solid state fermentation, or liquid surface culture. Towards the end of fermentation, as nutrients are depleted, cells begin the transition from growth phase to sporulation phase, such that the final product of fermentation is largely spores, metabolites, and residual fermentation medium. Sporulation is part of the natural life cycle of most microorganisms, in particular bacteria, and is generally initiated by the cell in response to nutrient limitation. Fermentation is configured to obtain high levels of colony forming units (“cfu”) of the bacteria and to promote sporulation. The bacterial cells, spores, and metabolites in culture media resulting from fermentation may be used directly or concentrated by conventional industrial methods, such as centrifugation, tangential-flow filtration, depth filtration, and evaporation. Fermentation broth and broth concentrate are both referred to herein as “fermentation products.” Compositions of the present disclosure include fermentation products. In some embodiments, the concentrated fermentation broth is washed, for example, via a diafiltration process, to remove residual fermentation broth and metabolites.

The fermentation broth or broth concentrate can be dried with or without the addition of carriers using conventional drying processes or methods including, but not limited to, spray drying, freeze drying, tray drying, fluidized-bed drying, drum drying, or evaporation.

The resulting dry products may be further processed, such as by milling or granulation, for example, to achieve a specific particle size (e.g., an average particle size of about 1 to about 5,000, about 1 to about 2,500, about 1 to about 500, about 1 to about 250, about 1 to about 100, about 1 to about 50, about 1 to about 25, about 1 to about 10 μm, or any other particle size or range thereof desired and known in the art) or physical format. Carriers, described below, may also be added post-drying.

Cell-free preparations of fermentation broth of the novel variants and strains of Bacillus of the present invention can be obtained by any means known in the art, such as extraction, centrifugation and/or filtration of fermentation broth. Those of skill in the art will appreciate that so-called cell-free preparations may not be devoid of cells, but rather are largely cell-free or essentially cell-free, depending on the technique used (e.g., speed of centrifugation) to remove the cells. The resulting cell-free preparation may be dried and/or formulated with components that aid in its application to plants or to plant growth media. Concentration methods and drying techniques described above for fermentation broth are also applicable to cell-free preparations.

In the case of Bacillus pumilus strain QST2808, metabolites can be obtained according to the methods set forth in International PCT Patent Application published as WO 00/58442. The term “metabolites” as used herein may refer to semi-pure and pure or essentially pure metabolites, or to metabolites that have not been separated from the concerned living organism.

Concentration methods and drying techniques described above for formulation of fermentation broth are also applicable to metabolites.

Compositions of the present invention may include formulation inerts added to compositions comprising cells, cell-free preparations, or metabolites to improve, efficacy, stability, and usability and/or to facilitate processing, packaging, and end-use application. Such formulation inerts and ingredients may include carriers, stabilization agents, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the carrier is a binder or adhesive that facilitates adherence of the composition to a plant part, such as a seed or root. See, e.g., Taylor, A. G., et ah, “Concepts and Technologies of Selected Seed Treatments”, Annu. Rev. Phytopathol. 28: 321-339 (1990). The stabilization agents may include anti-caking agents, anti-oxidation agents, desiccants, protectants, or preservatives. The nutrients may include carbon, nitrogen, and phosphors sources such as sugars, polysaccharides, oil, proteins, amino acids, fatty acids, and phosphates. The physical property modifiers may include bulking agents, wetting agents, thickeners, pH modifiers, rheology modifiers, dispersants, adjuvants, surfactants, antifreeze agents, or colorants. In some embodiments, the composition comprising cells, cell-free preparation, or metabolites produced by fermentation can be used directly with or without water as the diluent without any other formulation preparation. In some embodiments, the formulation inerts are added after concentrating fermentation broth and during and/or after drying.

Compositions of the present disclosure may include carriers, which are inert formulation ingredients added to fermentation products or cell-free preparations to improve recovery, efficacy, or physical properties and/or to aid in packaging and administration. Such carriers may be added individually or in combination.

The compositions of the present disclosure may be mixed with other chemical and non-chemical additives, adjuvants, and/or treatments, wherein such treatments include but are not limited to chemical and non-chemical fungicides, insecticides, miticides, nematicides, fertilizers, nutrients, minerals, auxins, growth stimulants, and the like.

Fungicides with which the biological control agents of the present invention may be mixed are chemical or biological fungicides.

In some embodiments, the chemical or biological fungicide is a commercially available formulated product and is tank mixed with the compositions of the present disclosure. In other embodiments, the chemical or biological fungicide is mixed with the biological control agent prior to formulation such that the compositions form one formulated product.

An “effective amount” is an amount sufficient to effect beneficial or desired results. An effective amount can be applied in one or more applications. In terms of treatment and protection, an “effective amount” is an amount sufficient to control the disease, more specifically to ameliorate, stabilize, reverse, slow or delay progression of the disease.

The application of the compositions comprising a biological control agent may be administered as a foliar spray, as a treatment of a propagating part of the plant (e.g. a seed or tuber) and/or as a soil treatment.

According to a particular embodiment, the compositions described herein are applied to grapevine plants, or plant parts, preferably the aerial plant parts such as buds, flowers, leaves, grapes, trunk (or arms), or stems (canes). The compositions of the present invention are preferably sprayed on the entire grapevine plants, so as to be in contact with all aerial parts of the plants.

The compositions comprising a biological control agent may be applied on the crop plants in a field as part of a treatment program. Usually, a field of crop plants does not receive only one treatment of crop protection products, but rather several ones of the same or different crop protection products, that are planned to be applied on the crop field sequentially over the development of the crop, for an optimal protection of the crop. Such an optimal treatment planning is a treatment program. More specifically, a treatment program may comprise the use of different crop protection products, which may be chemical products or biological control agents, or both. With the aim to reduce the use of chemical products, a treatment program preferably comprises both chemical products and biological control agents. When biological control agents are integrated into treatment programs, they have to be optimally placed in such treatment programs, i.e. at a stage of crop development or stage of development of a given pest intended to be controlled (e.g. the stage of infection by a plant fungal pathogen) that allows its optimal controlling efficacy.

According to a specific embodiment, the biological control agent is used in the methods according to the invention as part of a treatment program which may comprise additional treatments with chemical crop protection products and/or other biological control agents. When the biological control agent is included in a treatment program aimed at controlling certain plant fungal pathogens, it is preferably positioned at the beginning of the incubation period of such plant fungal pathogens.

In situations where a certain plant fungal pathogen has not been successfully controlled and has therefore been able to develop in a crop field, the treatment program may then foresee treatments with crop protection products that are known to be able to control fully-installed plant fungal pathogens. When such treatments are made, the crop is usually cured from the concerned plant fungal pathogen. The risk of a second or further infestation by the plant fungal pathogen may however still exist. Accordingly, if detection is made of a second or further infection by a plant fungal pathogen that is at the beginning of the incubation period, the biological control agent may also be applied at such time according to the methods of the present invention.

The crop protection products that may be included in the treatment programs may be chemical products or biological control agents, or both.

The chemical products that may be applied for controlling plant pathogens are chemical fungicides. Example of such chemical fungicides may be:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluoro-phenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]-sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methyl imidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]-phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoro-methyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034)N-(2-cyclopentyl-5-fluorobenzyl)-N-cyclopropyl-3-(difluoromethyl)-5-fluoro-1-methyl-1H-pyrazole-4-carboxamide, (2.035)N-(2-tert-butyl-5-methylbenzyl)-N-cyclopropyl-3-(difluoromethyl)-5-fluoro-1-methyl-1H-pyrazole-4-carboxamide, (2.036)N-(2-tert-butylbenzyl)-N-cyclopropyl-3-(difluoromethyl)-5-fluoro-1-methyl-1H-pyrazole-4-carboxamide, (2.037)N-(5-chloro-2-ethylbenzyl)-N-cyclopropyl-3-(difluoromethyl)-5-fluoro-1-methyl-1H-pyrazole-4-carboxamide, (2.038) isoflucypram, (2.039)N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040)N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041)N-[1-(2,4-dichlorophenyl)-1-methoxypropan-2-yl]-3-(difluoromethyl)-1-methyl-1H-pyrazole-4-carboxamide, (2.042)N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045)N-cyclopropyl-3-(difluoromethyl)-5-fluoro-1-methyl-N-[5-methyl-2-(trifluoromethyl)benzyl]-1H-pyrazole-4-carboxamide, (2.046)N-cyclopropyl-3-(difluoromethyl)-5-fluoro-N-(2-fluoro-6-isopropylbenzyl)-1-methyl-1H-pyrazole-4-carboxamide, (2.047)N-cyclopropyl-3-(difluoromethyl)-5-fluoro-N-(2-isopropyl-5-methylbenzyl)-1-methyl-1H-pyrazole-4-carboxamide, (2.048)N-cyclopropyl-3-(difluoromethyl)-5-fluoro-N-(2-isopropylbenzyl)-1-methyl-1H-pyrazole-4-carbothioamide, (2.049)N-cyclopropyl-3-(difluoromethyl)-5-fluoro-N-(2-isopropylbenzyl)-1-methyl-1H-pyrazole-4-carboxamide, (2.050)N-cyclopropyl-3-(difluoromethyl)-5-fluoro-N-(5-fluoro-2-isopropylbenzyl)-1-methyl-1H-pyrazole-4-carboxamide, (2.051)N-cyclopropyl-3-(difluoromethyl)-N-(2-ethyl-4,5-dimethylbenzyl)-5-fluoro-1-methyl-1H-pyrazole-4-carboxamide, (2.052)N-cyclopropyl-3-(difluoromethyl)-N-(2-ethyl-5-fluorobenzyl)-5-fluoro-1-methyl-1H-pyrazole-4-carboxamide, (2.053)N-cyclopropyl-3-(difluoromethyl)-N-(2-ethyl-5-methylbenzyl)-5-fluoro-1-methyl-1H-pyrazole-4-carboxamide, (2.054)N-cyclopropyl-N-(2-cyclopropyl-5-fluorobenzyl)-3-(difluoromethyl)-5-fluoro-1-methyl-1H-pyrazole-4-carboxamide, (2.055)N-cyclopropyl-N-(2-cyclopropyl-5-methylbenzyl)-3-(difluoromethyl)-5-fluoro-1-methyl-1H-pyrazole-4-carboxamide, (2.056)N-cyclopropyl-N-(2-cyclopropylbenzyl)-3-(d ifluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027)N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.
4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023)N-(2-bromo-6-fluorophenyl)-4-(2-chloro-4-fluorophenyl)-1,3-dimethyl-1H-pyrazol-5-amine, (4.024)N-(2-bromophenyl)-4-(2-chloro-4-fluorophenyl)-1,3-dimethyl-1H-pyrazol-5-amine, (4.025)N-(4-chloro-2,6-difluorophenyl)-4-(2-chloro-4-fluorophenyl)-1,3-dimethyl-1H-pyrazol-5-amine.

5) Compounds having a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′, 4′:5,6][1,4]dithiino[2,3-c][1,2]thiazole-3-carbonitrile.

6) Compounds inducing a host defense, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyrid in-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds acting as an uncoupler, for example (14.001) fluazinam, (14.002) meptyldinocap.

15) Further compounds, for example (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2[3,5-bis(difluoromethyl)-1H-pyrazol-1-yl]-1-[4-(4-{5[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperid in-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen.

All named mixing partners of the classes (1) to (15) as described here above can be present in the form of the free compound and/or, if their functional groups enable this, an agriculturally acceptable salt thereof.

The biological control agents that may be applied for controlling plant pathogens are biological fungicides. Example of such biological fungicides may be any of those described herein above.

The various aspects of the invention will be understood more fully by means of the experimental examples below.

All the methods or operations described below are given by way of example and correspond to a choice, made among the various methods available for achieving the same result. This choice has no effect on the quality of the result, and, consequently, any appropriate method can be used by those skilled in the art to achieve the same result. In particular, and unless otherwise specified in the examples, all the recombinant DNA techniques employed are carried out according to the standard protocols described in Sambrook and Russel (2001, Molecular cloning: A laboratory manual, Third edition, Cold Spring Harbor Laboratory Press, NY) in Ausubel et al. (1994, Current Protocols in Molecular Biology, Current protocols, USA, Volumes 1 and 2), and in Brown (1998, Molecular Biology LabFax, Second edition, Academic Press, UK). Standard materials and methods for plant molecular biology are described in Croy R. D. D. (1993, Plant Molecular Biology LabFax, BIOS Scientific Publications Ltd (UK) and Blackwell Scientific Publications (UK)). Standard materials and methods for PCR (Polymerase Chain Reaction) are also described in Dieffenbach and Dveksler (1995, PCR Primer: A laboratory manual, Cold Spring Harbor Laboratory Press, NY) and in McPherson et al. (2000, PCR—Basics: From background to bench, First edition, Springer Verlag, Germany).

### EXAMPLES

### Example 1: Effect of Bacillus pumilus Strain QST2808 on Grape Powdery Mildew, Erysiphe necator, in Field Conditions

Filed trials were carried out in selected vineyard fields and in conditions of natural infestation by the grape powdery mildew, Erysiphe necator. The natural apparition and the development of powdery mildew in the test fields was monitored with a qPCR detection tool specific to Erysiphe necator, as described in International PCT Patent Application WO2017/009251.

Bacillus pumilus strain QST2808 was used in its commercial form, marketed in France under the brand name Sonata®.

The tests were carried out in two different locations in vineyards planted with two different grapevine cultivars, both equally susceptible to powdery mildew:

Location 1: Goult, south-east of France. Grapevine cultivar: Roussanne.
Location 2: Cuxac d'Aude, south of France. Grapevine cultivar: Chardonnay.

For the tests, Bacillus pumilus strain QST2808 was used in a treatment program, also containing other fungicidal products.

A comparative treatment was made using a sulfur-based product instead of Bacillus pumilus strain QST2808.

Controls received no treatments.

The treatment programs were as follows:

An additional comparative treatment program was applied (the “Less QST” program), having QST2808 as the first three treatments of the program, but lacking either the first or the first three treatments, and having Sulfur as the last three treatments of the program, as described in the diagram below.

On the two locations, treatments were made at the same development stages of the vineyard.

The development of the disease was assessed by two different means.

First, the infestation by Erysiphe necator was assessed molecularly on leaves at the time of the first treatment, using the qPCR tool described in International PCT Patent Application WO2017/009251. At this moment in time, no visual symptoms of the disease are observable. Second, the development of the symptoms of the disease was visually assessed on fully developed bunches 3 to 4 weeks after the latest treatment of the programs.

Visual observations of symptoms on grape bunches were performed by sampling about a hundred bunches on the same experimental plot in several plants, counting the number of infected bunches and assessing the percentage of bunch area infected.

The results of the visual observations of symptoms are expressed as percentages of efficacy of the treatment program relatively to the untreated controls, according to the following formula:

((Symptoms in controls−Symptoms in treated)/Symptoms in controls)×100

qPCR Detection

Results of the qPCR measurements showed that Erysiphe necator was already well present at the beginning of the treatment program at the Goult site (9 out of 10 tested leaves showing detectable levels of the fungi), whereas it was much less present at the Cuxac d′Aude site (no infected leaves at the beginning of the treatment program, 3 infected leaves out of 10 after the first treatment, and 1 leaf out of 20 after the second treatment). In absence of observable visual symptoms, the infestation situation at the beginning of the treatment was therefore different between the two experimental sites.

### Visual Observation of Symptoms on Grape Bunches

Symptom observations on grape bunches were carried out several weeks after the end of the treatment programs, on fully developed bunches. These observations were made on both sites.

Results at the Goult site are in Table 1:

| Program type | QST2808 | Sulfur | Less QST⁽¹⁾ |
|---|---|---|---|
| % Efficacy | 97.4 | 99.1 | 99.1 |

⁽¹⁾lacking the first three treatments with QST2808

The results of these observations suggest that the first three treatments with QST2808 had no contribution to the good efficacy levels observed for the three treatment programs.

Results at the Cuxac d'Aude site are in Table 2:

| Program type | QST2808 | Sulfur | Less QST⁽²⁾ | Less QST⁽³⁾ |
|---|---|---|---|---|
| % Efficacy | 94.9 | 87.8 | 96.8 | 76.7 |

⁽²⁾lacking only the first treatment with QST2808
⁽³⁾lacking the first three treatments with QST2808

The results of these observations suggest that the early treatments with QST2808 do have an effective contribution to the good efficacy levels observed for the treatment programs. When more than one of these pre-flowering early treatments is removed, the global efficacy of the treatment program is reduced.

Taken together, the results on grape bunches at the two sites, combined with the qPCR information at the beginning of the treatment programs, suggest that the early QST2808 treatments cannot contribute to control the development of Erysiphe necator if such early treatments are made once the pathogen is already well present in the grape field. On the other hand, those results suggest that the early QST2808 treatments do contribute to the control of the development of Erysiphe necator if such early treatments are made when the pathogen is slightly detectable (i.e. when infestation of the field is at the beginning of the incubation period).

### Example 2: Effect of a Biological Control Agent Containing COS and OGA on Grape Powdery Mildew, Erysiphe necator, in Field Conditions

In the very same conditions, same locations and at the same time as the experiment carried out in Example 1, the same experiment was reproduced by substituting the treatments with Bacillus pumilus strain QST2808 by treatments with another biological control agent containing a mixture of chito-oligo-saccharides (COS) and oligo-galacturonides (OGA).

This biological control agent was used in its commercial form, marketed in France under the brand name Bastid®.

Visual Observation of Symptoms on Grape Bunches Symptom observations on grape bunches were carried out several weeks after the end of the treatment programs, on fully developed bunches. These observations were made on both sites.

Results at the Goult site are in Table 3:

| Program type | Bastid ® | Sulfur | Less Bastid ® ⁽¹⁾ |
|---|---|---|---|
| % Efficacy | 96.8 | 99.1 | 99.1 |

⁽¹⁾ lacking the first three treatments with Bastid ®

The results of these observations suggest that the first three treatments with Bastid® had no contribution to the good efficacy levels observed for the three treatment programs.

Results at the Cuxac d'Aude site are in Table 4:

| Program type | Bastid ® | Sulfur | Less Bastid ® ⁽²⁾ |
|---|---|---|---|
| % Efficacy | 95.4 | 87.8 | 77 |

⁽²⁾ lacking the first three treatments with Bastid ®

The results of these observations suggest that the early treatments with Bastid® do have an effective contribution to the good efficacy levels observed for the treatment programs. When more than one of these pre-flowering early treatments is removed, the global efficacy of the treatment program is reduced.

Taken together, the results on grape bunches at the two sites, combined with the qPCR information at the beginning of the treatment programs, suggest the early Bastid® treatments cannot contribute to control the development of Erysiphe necator if such early treatments are made once the pathogen is already well present in the grape field. On the other hand, those results suggest that the early Bastid® treatments do contribute to the control of the development of Erysiphe necator if such early treatments are made when the pathogen is slightly detectable (i.e. when infestation of the field is at the beginning of the incubation period).

1. A method for controlling the infestation of a plant by a plant fungal pathogen having a long incubation period using a biological control agent, characterized in that an effective amount of the biological control agent is applied on the plant when the infection by the plant fungal pathogen is at the beginning of the incubation period.

2. The method of claim 1, wherein the plant is a crop plant.

3. The method of claim 2, wherein the crop plant is in a crop field.

4. A method for controlling the infestation of a plant by a plant fungal pathogen having a long incubation period using a biological control agent, comprising the steps of:
(a) determining the stage of infection of the plant by the plant fungal pathogen before visual symptoms are observable, using a means of detection of the plant fungal pathogen; and
(b) applying an effective amount of the biological control agent on the plant when the determination of step (a) reveals that the infection by the plant fungal pathogen is at the beginning of the incubation period.

5. Method A method for controlling the infestation of a crop field by a plant fungal pathogen having a long incubation period using a biological control agent, comprising the steps of:
(a) determining if the crop field is at risk of infection by the plant fungal pathogen, by measuring certain parameters associated with the development of the plant fungal pathogen, the resulting information of those measures being used for then calculating a probability of such development in the crop field;
(b) if the determination of step (a) finds that the crop field is at risk, then determining the stage of infection of the field by the plant fungal pathogen before visual symptoms are observable, using a means of detection of the plant fungal pathogen;
(c) applying an effective amount of the biological control agent on the field when the determination of step (a) reveals that the infection by the plant fungal pathogen is at the beginning of the incubation period.

6. The method of claim 5, wherein the determination of step (a) is carried out using a digital means comprising one or more computer programs aimed at calculating a risk of infection of a given field, whereby the information resulting from the measured parameters is used by such digital means for making such calculation.

7. The method of claim 1, wherein the plant fungal pathogen having a long incubation period is the fungus grape powdery mildew Erysiphe necator, and the plant or crop is the grapevine.

8. The method of claim 1, wherein the biological control agent comprises the Bacillus pumilus strain QST2808.

9. The method of claim 1, wherein the determination that the infection by the plant fungal pathogen is at the beginning of the incubation period is made using a qPCR detection means specific to the considered plant fungal pathogen.

10. The method of claim 1, wherein the biological control agent is applied as part of a treatment program.

11. The method of claim 4, wherein the plant fungal pathogen having a long incubation period is the fungus grape powdery mildew Erysiphe necator, and the plant or crop is the grapevine.

12. The method of claim 4, wherein the biological control agent comprises the Bacillus pumilus strain QST2808.

13. The method of claim 4, wherein the determination that the infection by the plant fungal pathogen is at the beginning of the incubation period is made using a qPCR detection means specific to the considered plant fungal pathogen.

14. The method of claim 4, wherein the biological control agent is applied as part of a treatment program.

15. The method of claim 5, wherein the plant fungal pathogen having a long incubation period is the fungus grape powdery mildew Erysiphe necator, and the plant or crop is the grapevine.

16. The method of claim 5, wherein the biological control agent comprises the Bacillus pumilus strain QST2808.

17. The method of claim 5, wherein the determination that the infection by the plant fungal pathogen is at the beginning of the incubation period is made using a qPCR detection means specific to the considered plant fungal pathogen.

18. The method of claim 5, wherein the biological control agent is applied as part of a treatment program.
